(19) United States
(12) Patent Application Publication
(10) Pub. No.: US 2012/0101192 A1
(43) Pub. Date: Apr. 26, 2012

(54) COMPOSITION, METHOD FOR PREPARING SAME, AND USE THEREOF FOR IMPROVING THE FLUIDITY AND TEMPERATURE RESISTANCE OF COMPOSITE MATERIALS

(75) Inventors: Jacques Barbier, Montamise (FR); Cedric Dever, Jaunay-Clan (FR)

(73) Assignee: VALAGRO CARBONE RENOUVELABLE POITOU-CHARENTES, Poitiers (FR)

(21) Appl. No.: 13/380,910

(22) PCT Filed: Jul. 12, 2010
(86) PCT No.: PCT/FR2010/051465

§ 371 Date: Dec. 27, 2011

(30) Foreign Application Priority Data
Jul. 13, 2009 (FR) 09 54864

(51) Int. Cl. C08L 67/04; C08K 13/08

(52) U.S. Cl. 524/9

(57) ABSTRACT

A composition or master batch including at least one functionalized polyglycerol, at least one biopolymer, and a meal obtained from plant carbon, and its use for improving the fluidity in the molten state and the heat resistance of composite materials, in particular composites based on biopolymers that are optionally loaded with plant meal. Also, a process for the preparation of this composition, as well as the materials that integrate it.

This invention relates to a composition, a master batch, that is useful for improving the heat resistance and fluidity in the molten state of composite materials, in particular composites based on biodegradable polymer(s) optionally loaded with plant meal(s).

The invention also relates to a process for preparation of said master batch, its use, and the composite materials that incorporate it.

It is known that the materials with controlled biodegradability are increasingly sought after, in particular the materials that can break down in a natural environment, without requiring that microorganisms, such as materials based on mixtures of biodegradable polymer(s) or biopolymers and plant meal(s), be specifically supplied.

These materials, based on biopolymers or mixtures of biopolymers and plant meals, are generally used by implementing techniques such as injection, blowing extrusion, inflation extrusion, calendaring, etc., which require a significant fluidity in the molten state and a high heat resistance.

However, the biopolymers and the biopolymer/plant meal mixtures have a low fluidity in the molten state and/or a low heat resistance.

One approach that is used for improving the fluidity of these materials is to add a plasticizer to them, for example a phthalate, a benzoate, an epoxide, etc., that makes it possible to generate a product that is flexible, resistant, and easier to manipulate.

The role of a plasticizer is multiple. It should have an excellent compatibility with the biopolymer or the composite to be plasticized, have a plasticizing effect, and not show any loss of performance because of volatilization or exudation.

However, the plasticizers that are currently used in the polymer industry are of petrochemical origin, are non-renewable, and are not biodegradable.

The ultimate result therefore is materials that are not good for the environment and that do not break down entirely.

To respond to this ecological problem, plasticizers obtained from natural molecules have been developed to be used with bioplastics. By way of example, it is possible to cite triacetine (N. Ljungberg and B. Wesselen, J Appl Polym Sci 86 (2002), p. 1227), citrate derivatives (L. V. Labrecque, R. A. Kumar, V. Dave, R. A. Gross and S. P. McCarthy, J Appl Polym Sci 66 (1997), p. 1507), polyethylene glycol or PEG (S. Jacobsen and H. G. Fritz, Polym Eng Sci 39 (1999), p. 1303), and polyethylene oxide (A. J. Nijenhuis, E. Colstee, D. W. Grijpma, and A. J. Pennings, Polymer 37 (1996), p. 5849).

These plasticizers of natural origin, however, have drawbacks in terms of performances and mechanical characteristics and are not satisfactory approaches.

Furthermore, relative to the improvement of the temperature resistance of the composite materials, it is advisable to increase their degree of crystallization. Actually, it is known that the heat resistance of semi-crystalline polymers such as polyethylene terephthalate increases with their degree of crystallinity. Numerous approaches have thus been developed, such as, for example, the addition of agents for nucleations or post-crystallization after transformation, as disclosed in the patent application EP-1,463,619. However, these treatments are not satisfactory in particular in terms of efficiency, simplicity and cost.

There is therefore a need for an efficient product that can both improve fluidity in the molten state and the heat resistance of biodegradable polymers and materials based on biodegradable polymers, while preserving their mechanical properties and their degradable nature.

This is to what this invention corresponds by proposing a composition or master batch, comprising at least one functionalized polyglycerol, at least one biopolymer, and at least one meal obtained from plant carbon, and optionally a plasticizer.

Actually, surprisingly enough, the co-mixture of functionalized polyglycerol, biopolymer, and meal obtained from plant carbon has noteworthy properties as a plasticizer and as an enhancer of the heat resistance of composite materials.

Functionalized polyglycerol is defined as a polyglycerol that is obtained by condensing multiple glycerol units on themselves and for which some or all of the hydroxyl groups have been replaced by other groups, preferably ester groups. Such a molecule corresponds to one of the following formulas (1) and (2):

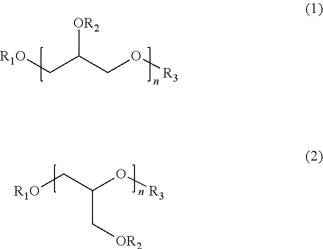

in which R1, R2, and R3 represent hydrogens or fatty acid chains.

Biopolymer is defined as any biodegradable and/or bio-sourced polymer. A biodegradable polymer is a polymer that breaks down by the action of microorganisms in the form of CO2, water, and a new biomass. A bio-sourced polymer is a polymer that is obtained completely or partially from renewable resources.

Meal that is obtained from plant carbon in terms of the invention is defined both as meal obtained from grains as well as lignocellulosic meal.

Master batch in terms of the invention is defined as a mixture based on one or more polymer(s) that is/are heavily loaded with at least one additive or at least one feedstock, designed to be diluted next into another mixture so as to introduce therein said additive or said feedstock.

The invention also relates to the use of this composition or master batch for increasing the fluidity in the molten state and the heat resistance of composite materials.

In particular, the purpose of the invention is the use of this biodegradable composition as a plasticizer and enhancer of the heat resistance of composites based on biopolymer(s) and/or biopolymer(s) loaded with plant meal(s).

The purpose of the invention is also a particular process for preparation of the composition of functionalized polyglycerol, biopolymer, and meal obtained from plant carbon.

Finally, the invention also relates to the biopolymer-based composites that are optionally loaded with plant meal, comprising the composition that consists of at least one functionalized polyglycerol, at least one biopolymer, and a meal obtained from plant carbon.

Advantageously, this invention makes it possible to obtain formulations based on biodegradable polymers and/or based on biodegradable polymers that are loaded with plant meal(s) and that have a significant fluidity in the molten state and a good heat resistance, while being obtained completely from resources that are natural and therefore not harmful to the environment.

Other characteristics and advantages will emerge from the following detailed description of the invention.

The purpose of this invention is therefore a composition or master batch that comprises at least one functionalized polyglycerol, at least one biopolymer, and a meal that is obtained from plant carbon.

The meals that are obtained from plant carbon are preferably native grain meals, such as wheat meals, or of lignocellulosic origin, such as wood meals. Native meal is defined as a meal that is obtained by grinding raw material without purification or addition of adjuvants.

Very preferably, the meals that are obtained from plant carbon are starched meals.

The starched meals can be selected from among:
Amylased cereal grain meals, such as wheat, corn or rye meals,
Protein meals, such as meals of horse beans, lupin, canola, sunflower, soybean or casein, and
Lignocellulosic meals, such as fibers of wood, hemp, or linen.

According to one preferred embodiment, the functionalized polyglycerol is a polyglycerol ester. Preferably, it is a polyglycerol ester that has a degree of polymerization of 1 to 20 with one or more acid groups selected from among:
Saturated fatty acids of C1 to C32 such as stearic acid, arachidic acid, myristic acid, caprilic acid, isostearic acid, etc.,
Monounsaturated fatty acids, such as palmitoleic acid, oleic acid, erucic acid, nervonic acid, and
Polyunsaturated fatty acids, such as linoleic acid, α-linoleic acid, γ-linoleic acid, di-homo-γ-linoleic acid, arachidonic acid, eicosapentaenoic acid, and docosahexanoic acid.

According to another embodiment, the functionalized polyglycerol is an acetylated polyglycerol or an acetylated and esterified polyglycerol.

By way of example, the polyricinoleate of polyglycerol is a functionalized polyglycerol that is particularly suitable for this invention.

According to the invention, the functionalized polyglycerols are used as plasticizers for composites that are based on polymers, in particular based on at least one biodegradable polymer that is loaded with plant meal.

By way of example, the biopolymers can be selected from among:
Starch and starch mixtures,
Polypeptides,
Polyvinyl alcohol,
Polyhydroxyalkanoates,
Polylactic acid and polylactates,
Cellulose, and
Polyesters.

Preferably, the master batch according to the invention comprises:
Between 1 and 15% by weight of functionalized polyglycerol,
Between 25 and 94% by weight of biopolymer(s), and
Between 5 and 60% by weight of meal that is obtained from plant carbon, preferably starched meal.

According to one variant, the composition according to the invention can also comprise a plasticizer. By way of example, it may be glycerol, citrate derivatives such as acetyl tributyl citrate, or water. It can be present in the composition between 1% and 20%, preferably between 2% and 8%.

Advantageously, the different components of the mixture according to the invention act in synergy and make it possible to improve both the fluidity in the molten state and the heat resistance of composite materials, in particular composite materials that are based on biopolymer(s) and optionally loaded with plant meal.

The composition according to the invention can be obtained by implementing a process that consists in extruding a mixture of one or more biodegradable polymers, meal obtained from plant carbon, and at least one functionalized polyglycerol at temperatures of between 50 and 300° C., and more particularly between 150 and 250° C.

The master batch that is obtained can next be introduced with a preparation of composite materials, in particular composite materials that are based on biopolymers that are optionally loaded with plant meal. The addition of the master batch to the preparation is done by extrusion.

Preferably, the content by mass of the master batch in the composite material is between 1% and 80%.

It may be, for example, composite materials based on biopolymer(s) that can be selected from among starch and starch mixtures, polypeptides, polyvinyl alcohol, polyhydroxyalkanoates, polydroxybutyrates, and polyhydroxyvalerates, polylactic acid and polylactates, cellulose, and polyesters. These biopolymers can be loaded with plant meals, such as, for example: amylased cereal grain meals, such as wheat, corn or rye meals, protein meals, such as meals of horse beans, lupin, canola, sunflower, soybean or casein, and lignocellulosic meals, such as fibers of wood, hemp, or linen.

Advantageously, the composites based on biodegradable polymers that are optionally loaded with plant meal comprising the master batch according to the invention have good mechanical properties, an improved fluidity in the molten state, as well as a better heat resistance. The master batch according to the invention has a good compatibility with the biopolymers or the composites whose properties it is necessary to improve. It also has a good plasticizing effect and does not show any loss in performance because of volatilization or exudation.

These characteristics can be illustrated by the following examples.

The examples are implemented on master batches based on polylactic acid (PLA), starched wheat meal, polyglycerol esters, and water.

For this example:
The traction characteristics of plastic materials have been determined according to the Standards ISO/R 527 and ISO 178,
The fluidity index in the molten state of the plastic materials follows the Standard ISO 1133,
The resiliency of the materials was determined according to the Standard ISO 179 using non-notched specimens,
Heat resistance was determined based on bending temperature under load (feedstock of 1.8 MPa, rate of temperature increase of 120±10 K/h) according to the Standard ISO 75.

The operating procedure is as follows.

Mixtures that contain x % PLA, y % starched wheat meal, polyglycerol esters such as polyglycerol polyricinoleate, an acetyl tributyl citrate-type plasticizer, and water were granulated using a co-rotating extruder Clextral BC21 (L=600 mm, L/d=24) at 170° C.

The products obtained by granulation are injected into an Arburg 100T press so as to form specimens necessary to their mechanical characterizations.

The results that are obtained are presented in the following table that indicates the mechanical and rheological characteristics of the different materials:

| Name of Mixture | | PLA AMI 7 | PLA AMI 11 |
|---|---|---|---|
| Content by Mass of the | | x = 54.3 | x = 56 |
| Components of the | | y = 17.4 | y = 34.5 |
| Mixture (%) | | | |
| Deformation Temperature | | 53 | 52 |
| Under Load (° C.) | | | |
| Resiliency, kJ/m² | | 6 | 4 |
| Fluidity in the Molten State | | 17 | 0.4 |
| (190° C., 5 kg) | | | |
| Traction | Maximum | 49 | 61 |
| | Constraint, | | |
| | MPa | | |
| | Elongation | 2 | 1 |
| | at Break | | |
| | Traction | 3,800 | 3,250 |
| | Module, MPa | | |

These results show well that the composition according to the invention has good thermal and plasticizing properties, while preserving the mechanical properties of the PLA, as well as its degradable nature in the natural environment.

Next, these master batches were tested so as to observe their effect when they are added to composite materials.

To do this, mixtures of PLA, polyhydroxyalkanoate, plant meal and plasticizer were granulated with or without the presence of a master batch of PLA AMI7 using a co-rotating extruder Clextral BC21 (L=600 mm, L/d=24) at 170° C.

It is noted that the addition of 20% by mass of the composition according to the invention makes it possible to improve the heat resistance of the composite material. Actually, the bending temperature under load switches from 39° C. without the mixture according to the invention to 51° C. after the mixture is added.

Likewise, the addition of 20% by mass of the composition according to the invention makes it possible to improve the fluidity in the molten state. Actually, fluidity under hot conditions switches from 7 g/10 minutes without the mixture to 15 g/10 minutes after adding the master batch according to the invention.

1. A composition comprising at least one functionalized polyglycerol, at least one biopolymer, and at least one meal that is obtained from plant carbon.

2. The composition according to claim 1, characterized in that it comprises:
Between 1 and 15% of functionalized polyglycerol(s)
Between 25 and 94% of biopolymer(s), and
Between 5 and 60% of meal obtained from plant carbon.

3. The composition according to claim 1, wherein the meal that is obtained from plant carbon is a native meal of grain or of lignocellulosic origin.

4. The composition according to claim 1, wherein the meal that is obtained from plant carbon is a starched meal.

5. The composition according to claim 1, wherein it also comprises a plasticizer.

6. The composition according to claim 5, wherein the plasticizer is included in the composition of between 1% and 20% by mass.

7. The composition according to claim 1, wherein the plasticizer is selected from among glycerol, the derivatives of citrate, and water.

8. The composition according to claim 1, wherein the functionalized polyglycerol is a functionalized polyglycerol ester with at least one acid group that is selected from among the saturated fatty acids, the monounsaturated fatty acids, and the polyunsaturated fatty acids.

9. A process for obtaining a composition according to claim 1, wherein it consists in extruding a mixture of one or more biodegradable polymers, meal that is obtained from plant carbon, and at least one functionalized polyglycerol, at temperatures of between 50 and 300° C.

10. A process for obtaining a composition according to claim 1, wherein it consists in extruding a mixture of one or more biodegradable polymers, meal obtained from plant carbon, and at least one functionalized polyglycerol, at temperatures of between 150 and 250° C.

11. A method for improving state fluidity and heat resistance of a composite material comprising adding a composition according to claim 1 in said composite material.

12. The method according to claim 11 in composite materials that are based on biodegradable polymer(s).

13. The method according to claim 11 in composite materials that are based on biodegradable polymer(s) that are loaded with plant meal(s).

14. A composite material based on biodegradable polymer(s) and/or biodegradable polymer(s) loaded with plant meal(s), wherein it comprises between 1 and 80% by mass of a composition according to claim 1.
